(19) United States
(12) Patent Application Publication
(10) Pub. No.: US 2007/0074029 A1
(43) Pub. Date: Mar. 29, 2007

(54) Data embedding apparatus

(75) Inventor: Naofumi Yamamoto, Kawasaki-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/236,802

(22) Filed: Sep. 28, 2005

(51) Int. Cl. H04L 9/00

(52) U.S. Cl. 713/176

(57) ABSTRACT

An image signal is smoothed, a superimposed signal having embedded data superimposed therein is generated, the superimposed signal is added to the smoothed image, and the image signal having the superimposed signal added thereto is binarized.

### BACKGROUND OF THE INVENTION

1. Field of the Invention

The present invention relates to a data embedding apparatus for embedding other data in an image.

2. Description of the Related Art

Superimposition of other data on an image enables recording of secondary data or prevention of falsification, forgery or the like. The following technologies have been disclosed for superimposition of other data in an image.

A book “Electronic Watermark Technology” compiled by Academic Society of Image Electronics, issued by Tokyo Denki University Publishing House, p. 43 to 44, Jan. 20, 2004, discloses a method of superimposing data in a digital image represented by a pseudo-tone. This method superimposes the data by utilizing freedom of representing a density based on a plurality of tone patterns when the density is represented by a pseudo-tone.

Jpn. Pat. Appln. KOKAI Publication No. 4-294862 discloses a method of specifying a copying machine or the like which executes recording from a hard copy output of a color copying machine. This method records a small yellow dot pattern superimposed on the hard copy output of the copying machine. The dot pattern has a shape to meet conditions such as a model number of the copying machine. This output is read by a scanner or the like, and the pattern recorded in the superimposed state is extracted to execute predetermined signal processing. As a result, the copying machine is identified.

Jpn. Pat. Appln. KOKAI Publication No. 7-123244 discloses a method of superimposing a color difference signal of a high frequency on a color image. This method encodes data to be superimposed, and superimposes a color difference component having a high spatial frequency peak corresponding to the code on an original image. The color difference component of the high spatial frequency is difficult to be seen by human vision. Accordingly, the superimposed data hardly deteriorates the original image. A general image contains almost no color difference component of a high frequency. As a result, the superimposed data can be reproduced by reading the superimposed image and executing signal processing to extract a color difference component of a high frequency.

There are other technologies available such as a method of slightly changing a space between characters, character inclination or a size in accordance with embedded data, and a method of adding a very small notch to a character edge.

### BRIEF SUMMARY OF THE INVENTION

In accordance with a main aspect of the present invention, a data embedding apparatus comprises a smoothing section for smoothing an image signal, a modulation section for generating a superimposed signal having embedded data superimposed therein, a superimposing section for adding the superimposed signal generated by the modulation section to the image signal smoothed by the smoothing section, and a binarizing section for binarizing the image signal to which the superimposed signal has been added by the superimposing section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a data embedding apparatus according to a first embodiment of the present invention;

FIG. 2 is a diagram showing a filter coefficient of a smoothing filter in a smoothing section;

FIG. 3 is an arrangement diagram showing frequency components of sine waves embedded by a modulation section;

FIG. 4 is a table showing correspondence between the frequency components;

FIG. 5 is a schematic diagram showing a part of an input image;

FIG. 6A is a graph showing a profile of an image signal before smoothing processing;

FIG. 6B is a graph showing a profile of an image signal after smoothing processing;

FIG. 7 is a table showing an example of embedded data;

FIG. 8A is a diagram showing an example of a superimposed signal obtained with respect to the embedded data;

FIG. 8B is a diagram showing an example of a superimposed signal obtained with respect to the embedded data;

FIG. 9A is a diagram showing an example of a result of adding embedded data to an image signal;

FIG. 9B is a diagram showing an example of a result of adding embedded data to an image signal;

FIG. 10A is a schematic diagram showing a part of an image input from an image input section;

FIG. 10B is a diagram showing a level of an image signal on a line S-S of the image;

FIG. 11 is a diagram showing a profile of a smoothed image signal;

FIG. 12 is a diagram showing an example of a waveform of a superimposed signal;

FIG. 13 is a diagram showing a profile of a smoothed image to which a superimposed signal has been added;

FIG. 14 is a diagram showing a concave and convex shape G compliant with embedded data added to an edge of an image signal;

FIG. 15 is a block diagram showing a data embedding apparatus according to a second embodiment of the present invention;

FIG. 16 is a schematic diagram of a signal near an edge;

FIG. 17 is an arrangement diagram of frequency components of sine waves embedded by a modulation section;

FIG. 18 is a table showing correspondence among the frequency components;

FIG. 19 is a block diagram showing a data embedding apparatus according to a fourth embodiment of the present invention;

FIG. 20 is a block diagram showing an image forming apparatus to which a data embedding apparatus is applied according to a fifth embodiment of the present invention; and

FIG. 21 is a flowchart of printing processing of the apparatus.

### DETAILED DESCRIPTION OF THE INVENTION

A first embodiment of the present invention will be described below with reference to the accompanying drawings.

FIG. 1 is a block diagram of a data embedding apparatus. An image input section 1 inputs an image as an image signal. The image signal is represented by, e.g., P (x, y). The image input section 1 has a scanner. The scanner reads, e.g., an image recorded on a sheet as an image recording medium, and outputs an image signal P (x, y). The image input section 1 receives image data from another apparatus through a network. The image signal P (x, y) output from the image input section 1 has an edge in which a signal level value steeply changes.

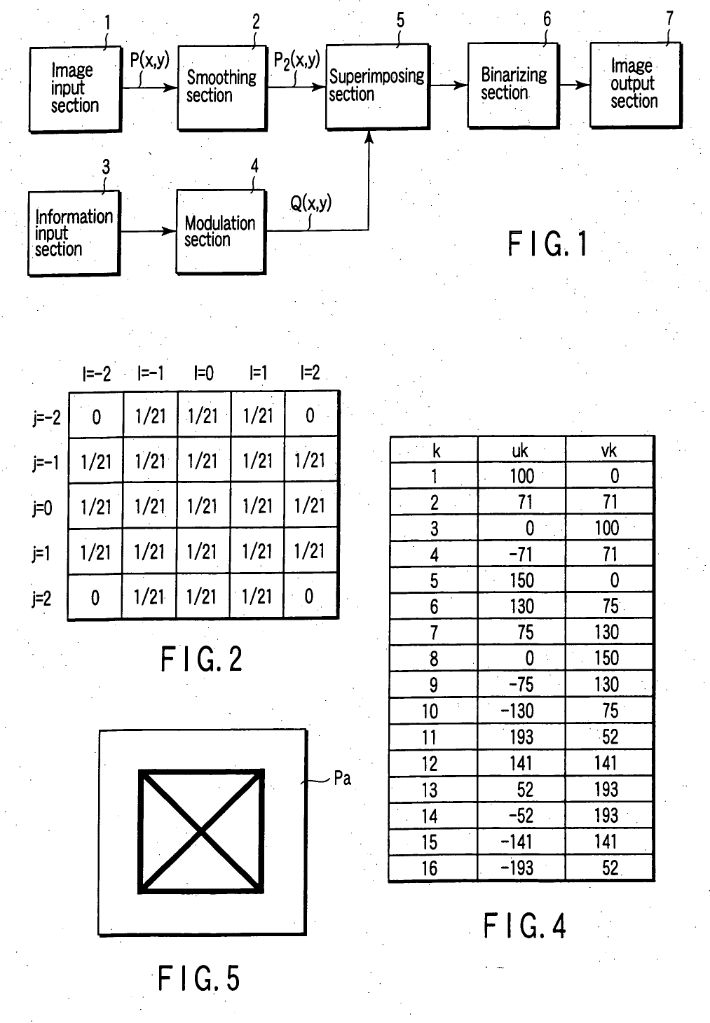

A smoothing section 2 smoothes the image signal P (x, y) output from the image input section 1. The smoothing section 2 has a smoothing filter. FIG. 2 shows an example of a kernel (filter coefficient) of the smoothing filter. The smoothing section 2 smoothes the image signal P (x, y) to set the edge to a medium signal level value. For example, the smoothing section 2 executes smoothing processing by the following equation (1). The smoothing section 2 executes, e.g., 5×5 pixel smoothing around a focused pixel. Accordingly, the smoothing section 2 rounds the edge which has the image signal P (x, y).

$${P}_{2} ( x , y ) = {\sum }_{- 2 \leq i \leq 2} {\sum }_{- 2 \leq j \leq 2} a ( ⅈ , j ) \cdot P ( x + ⅈ , y + j ) \qquad ( 1 )$$

wherein P₂ (x, y) represents an image signal after smoothing processing, and a (i, j) represents a filter coefficient.

A data input section 3 inputs data to be embedded in the image signal P (x, y) input from the image input section 1. For example, the embedded data is represented as a finite-bit digital signal. According to the embodiment, the embedded data is, e.g., a 16-bit digital signal.

A modulation section 4 generates a superimposed signal Q (x, y) having the embedding data from the data input section 3 superimposed therein. For example, the modulation section 4 generates the superimposed signal Q (x, y) by stacking 2-dimensional sine waves of 16 kinds of spatial frequencies. The superimposed signal Q (x, y) is generated by the following equation (2):

$$Q ( x , y ) = clip ( A \cdot {\sum }_{k} {f}_{k} \cdot cos ( 2 π ( {u}_{k} \cdot x + {v}_{k} \cdot y ) ) ) \qquad ( 2 )$$

Wherein x, y are pixel coordinate values on an image, Q (x, y) is a value of a superimposed signal of the coordinates x, y, uk, vk are k-th frequency components, fk is a kbit-th value of the embedded data, and fk=0 or 1 is established. For k, 0≦k≦−5 is established.

A is strength of the superimposed signal Q (x, y). It is presumed here that maximum strength of the image signal P (x, y) is 1, and A=0.2 is established. Additionally, clip (x) is a function of clipping a value within ±0.5. The clip (x) is represented by the following equations (3) to (5):
if (x<−0.5) clip (x)=−0.5 (3)
if (x>0.5) clip (x)=0.5 (4)
if (0.5>x>−0.5 clip (x)=x (5)

The image signal P (x, y) has portions such as a substrate portion, a thick character, and an inside of a graph other than the edge. By providing the clip function, a value of the superimposed signal Q (x, y) becomes −0.5≦Q (x, y)≦0.5. Thus, it is possible to prevent appearance of the superimposed signal Q (x, y) in the portions other than the edge.

The uk, vk are k-th frequency components of sine waves to be embedded. When values of the frequencies (uk, vk) are too high, the component of the superimposed signal Q (x, y) easily disappears during recording or reproducing. When values of the frequencies (uk, vk) are too low, embedded concave and convex data is easily seen visually to increase an inhibition feeling. When the two frequencies are close to each other, interference or erroneous detection easily occurs.

Therefore, it is advised to arrange uk, vk at a proper interval in a medium frequency band. The uk, vk are arranged in a proper frequency band in accordance with reliability of signal reproduction or a permissible level of an inhibition feeling of image quality decided by an application. In this case, a frequency absolute value is set within 100 dpi to 200 dpi, and a minimum distance between the two frequencies is set equal to or more than 50 dpi.

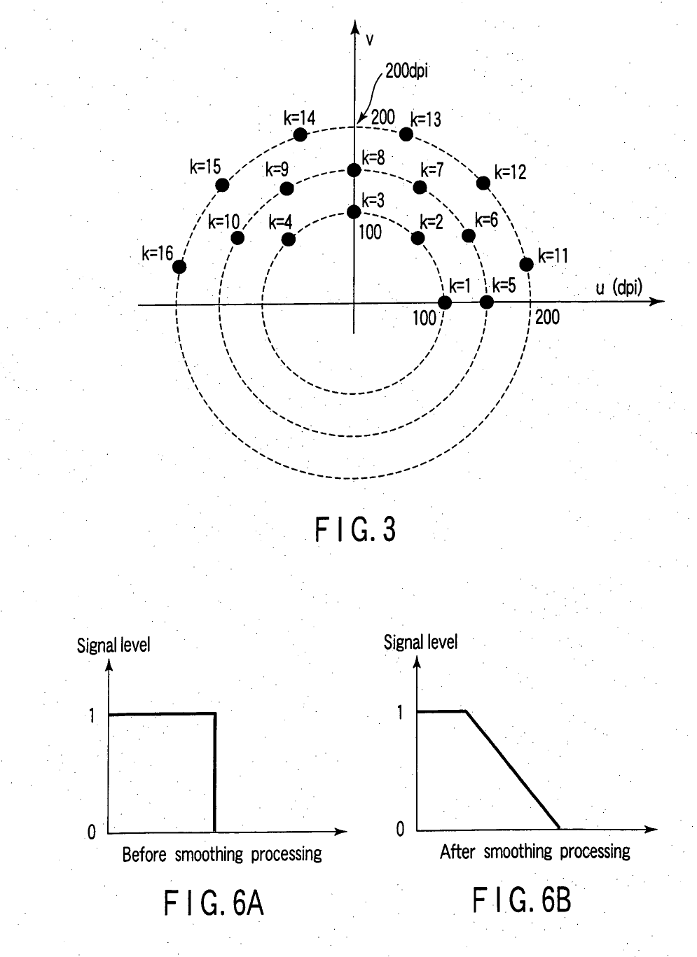

FIG. 3 is an arrangement diagram of k-th frequency components uk, vk of embedded sine waves on uv coordinates. In the arrangement of the frequency components uk, vk, a frequency distribution is symmetrical about an origin. Thus, areas (third, fourth image limits) of v<0 are omitted. FIG. 4 shows correspondence between the frequency components uk, vk.

A superimposing section 5 adds the superimposed signal Q (x, y) generated by the modulation section 4 to the edge of an image signal P₂ (x, y) smoothed by the smoothing section 2.

A binarizing section 6 binarizes the image signal to which the superimposed signal Q (x, y) has been added, and adds a concave and convex shape to the edge in accordance with the embedded data. The binarizing section 6 executes binarization processing represented by the following equations (6) to (8):
P₃(x, y)=P₂(x, y)+Q(x, y) (6)
P₄(x, y)=1(if P₃(x, y)≧0.5) (7)
P₄(x, y)=0 (if P₃(x, y)<0.5) (8)
An image output section 7 outputs the image signal binarized by the binarizing section 6. For example, the binarized image signal output from the image output section 7 is stored in a hard disk or the like, or directly printed on an image recording medium by a printer.

Next, a data embedding operation of the apparatus thus described will be described.

The image input section 1 inputs an image as an image signal P (x, y). FIG. 5 is a schematic diagram showing a part of the input image Pa. The image Pa has two levels only of black “1” and white “0”.

The smoothing section 2 smoothes the image signal P (x, y) output from the image input section 1 by, e.g., the smoothing filter of FIG. 2. Accordingly, an edge of the image signal P (x, y) becomes smooth to be set to a medium signal level value. In other words, the edge of the image signal P (x, y) is rounded. FIG. 6A shows a profile of the image signal P (x, y) before smoothing processing, and FIG. 6B shows a profile of an image signal P₂ (x, y) after smoothing processing.

The data input section 3 inputs embedded data represented as, e.g., finite-bit digital signal. FIG. 7 shows an example of embedded data. In the drawing, there are shown three types of embedded data. The embedded data is a 16-bit signal and represented by f(k) (1≦k≦16).

The modulation section 4 generates a superimposed signal Q (x, y) having the embedded data input from the data input section 3 superimposed therein. For example, the modulation section 4 generates the superimposed signal Q (x, y) by stacking 2-dimensional sine waves of 16 kinds of spatial frequencies together.

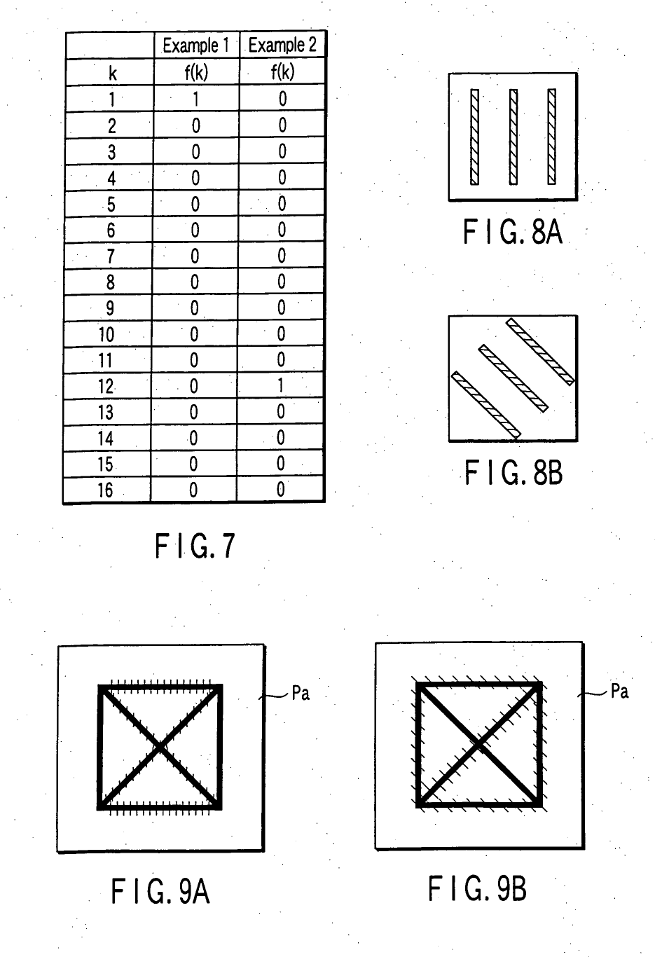

Each of FIGS. 8A and 8B shows an example of a superimposed signal Q (x, y) obtained by calculating the equation (2) for the embedded data. In the drawings, for convenience, a pixel in which a value of the superimposed signal Q (x, y) is positive is indicated by black, and a pixel in which it is negative is indicated by white. As can be understood from the equation (2), the superimposed signal Q (x, y) has a cyclical striped structure. Such superimposed signals Q (x, y) are different depending on patterns, angles of the patterns, intervals, or spatial frequencies in the image having the data embedded therein.

The superimposing section 5 adds the superimposed signal Q (x, y) generated by the modulation section 4 to the edge of the image signal smoothed by the smoothing section 2.

The binarizing section 6 binarizes the image signal to which the superimposed signal Q (x, y) has been added, and adds a concave and convex shape to the edge in accordance with the embedded data.

Each of FIGS. 9A and 9B shows an example of adding embedded data to an image signal. FIG. 9A shows an example of adding the superimposed signal Q (x, y) of FIG. 8A to the image Pa of FIG. 5. FIG. 9B shows an example of adding the superimposed signal Q (x, y) of FIG. 8B to the image Pa of FIG. 5. For these superimposed signals Q (x, y), angles applied to the patterns in the images are different from each other. A concave and convex shape is added only to an edge of a character or a line in the image in accordance with the embedded data.

Reasons for executing the smoothing and the binarization processing are as follows.

When the superimposed signal Q (x, y) is directly added to the image, a superimposed signal Q (x, y) is generated in a portion other than an edge of a substrate, an inside of a thick character or the like in the image. By executing smoothing processing, an area in which a level value of the image signal near the edge takes a medium value of (0.1, 1) can be created. A superimposed signal Q (x, y) within a range of −0.5≦Q (e, y)≦0.5 is added to this image to binarize the image. Accordingly, a concave and convex shape can be added only to the edge area in which the level value of the image signal is medium.

By executing the smoothing processing, the medium value varies depending on a distance from the edge. Thus, an isolated point is difficult to be generated in a position apart from the edge. For example, when an image is printed on a sheet, a very small isolated point is generally difficult to be reproduced, and causes instability. The generation difficulty of such an isolated point is preferable for stability.

The aforementioned data embedding operation is represented 1-dimensionally as follows.

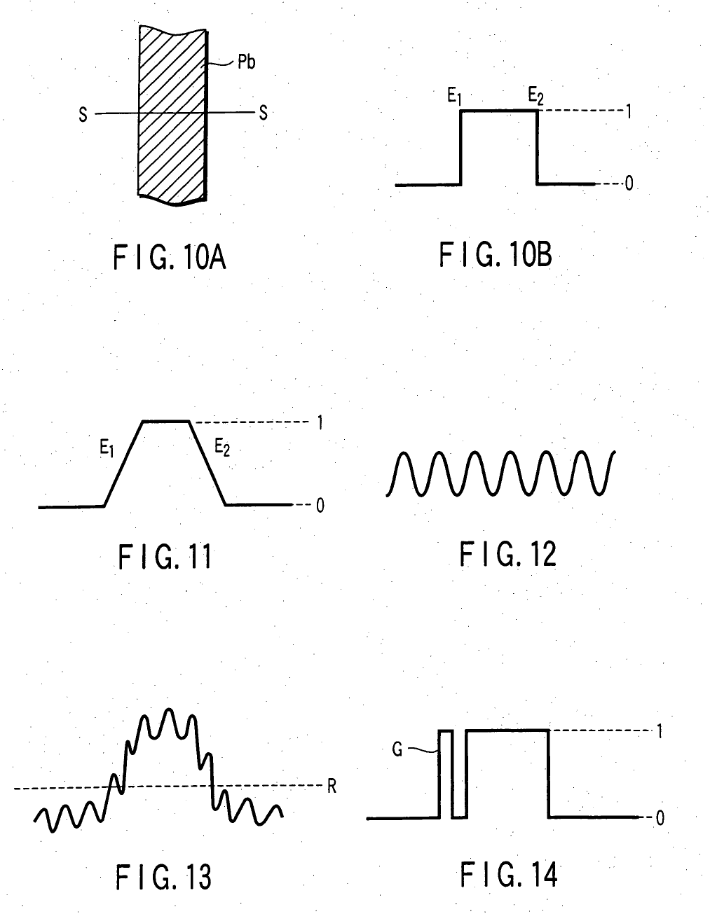

FIG. 10A shows a part of an image Pb input from the image input section 1. FIG. 10B shows a level of an image signal on an S-S line of the image Pb of FIG. 10B. For example, the image signal has levels of “1” and “0” corresponding to black and white. The image signal has edges E₁, E₂ in which signal levels steeply change from “1” to “0” and “0” to “1”.

The smoothing section 2 smoothes the image signal P (x, y) by, e.g., the smoothing filter of FIG. 2. The image signal P (x, y) is smoothed so that the edges E₁, E₂ become smooth profiles as shown in FIG. 11.

The modulation section 4 generates the superimposed signal Q (x, y) having the embedded data input from the data input section 3 superimposed therein. FIG. 12 shows an example of a waveform of the superimposed signal Q (x, y).

The superimposing section 5 adds the superimposed signal Q (x, y) generated by the modulation section 4 to the edge of the image signal P₂ (x, y) smoothed by the smoothing section 2. FIG. 13 shows a profile in which the superimposed signal Q (x, y) of FIG. 12 is added to the smoothed image signal P₂ (x, y) of FIG. 11.

As shown in FIG. 13, the binarizing section 6 binarizes the image signal to which the superimposed signal Q (x, y) has been added based on a threshold value R. As a result, as shown in FIG. 14, a concave and convex shape G is added to the edge of the image signal P (x, y) in accordance with the embedded data.

Thus, according to the first embodiment, the embedded data can be added to the edge by simple processing such as smoothing, and modulation, superimposition and binarization of the embedded data. As the concave and convex shape is added only to the edge portion near the edge, addition of the embedded data to the substrate or the inside of the thick character in the image is inhibited. Accordingly, no influence is given to the substrate or the inside of the thick character. As a uniform cyclic signal is added to the entire image, resistance to noise is high, and detection of embedded data is easy. As a result, it is possible to easily embed data in an image, mainly a binary image, such as a document image, a character or a line drawing.

Next, a second embodiment of the present invention will be described. Sections similar to those of FIG. 1 are denoted by similar reference numerals, and detailed description thereof will be omitted.

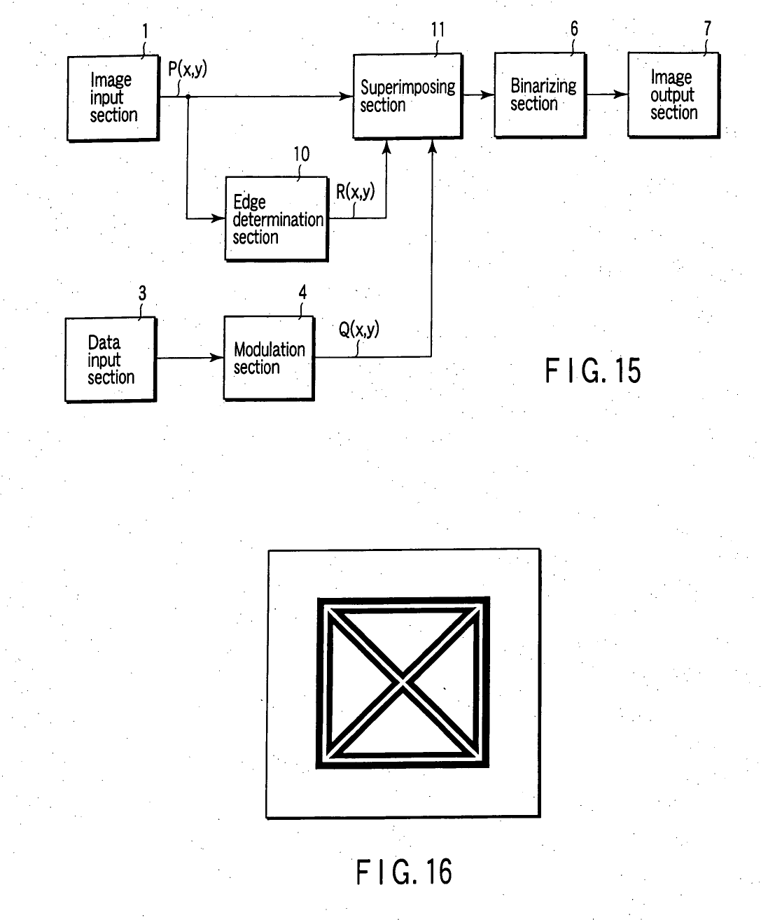

FIG. 15 is a block diagram of a data embedding apparatus. For this apparatus, a method of adding a concave and convex shape to an edge of an image signal P (x, y) is different from that of the first embodiment. An edge determination section 10 receives an image signal P (x, y) from an image input section 1, and determines an edge as an edge portion and an edge near area in the image signal P (x, y). The edge vicinity is an area whose distance from the edge, i.e., a pixel having black “1” and white “0” of the image reversed is within a predetermined value. For example, a determination method refers to an area having a distance from a focused pixel set within a predetermined value, and determines an edge near area if there are pixels of both black and white in this area. Hence, the edge determination section 10 outputs an edge near signal R (x, y) which is a result of the determination. FIG. 16 shows a processing result of the edge near signal R (x, y) with respect to the image input from the image input section 1.

A superimposing section 11 receives the image signal P (x, y), the edge near signal R (x, y), and a superimposed signal Q (x, y), and superimposes the superimposed signal Q (x, y) on the edge near portion alone, i.e., the edge near signal R (x, y)=1. In portions other than the edge near portion, the image signal P (x, y) is kept as it is. In other words, the superimposing section 11 executes processing of the following equation (9):
P₃(x, y)=P(x, y)+R(x, y)·(Q(x, y)+0.5) (9)

A binarizing section 6 binarizes the signal P₃ (x, y) obtained by the superimposing section 11, and adds a concave and convex shape to the edge.

Thus, according to the second embodiment, as the value of the superimposed signal Q (x, y) is binarized beforehand to one of “1” and “0”, the binarizing section is made unnecessary. As a result, a calculation amount of adding the embedded data to the edge can be lower than that of the first embodiment. Moreover, the concave and convex shape can be added irrespective of a distance from the edge. Hence, a possibility of generating an isolated point in a position apart from the edge is increased.

Next, a third embodiment of the present invention will be described. An apparatus of the embodiment is identical in configuration to that of FIG. 1, and thus FIG. 1 will be used.

An image input section 1 reads an image recorded in a sheet as an image recording medium by, e.g., a scanner, and outputs an image signal P (x, y). The image input section 1 receives image data from another apparatus through a network.

An image input from the image input section 1 may contain data of a frequency roughly equal to that of a superimposed signal Q (x, y) generated by a modulation section 4. In this case, it is difficult to determine whether the frequency of the image is a frequency component of embedded data or a frequency component originally present in the image.

To solve this problem, the modulation section 4 has plural groups of frequencies, each group consisting of two frequencies corresponding to each value of the embedded data. The modulation section 4 generates a superimposed signal Q (x, y) having embedded data superimposed therein by one of the frequencies of one group in accordance with each value of the embedded data.

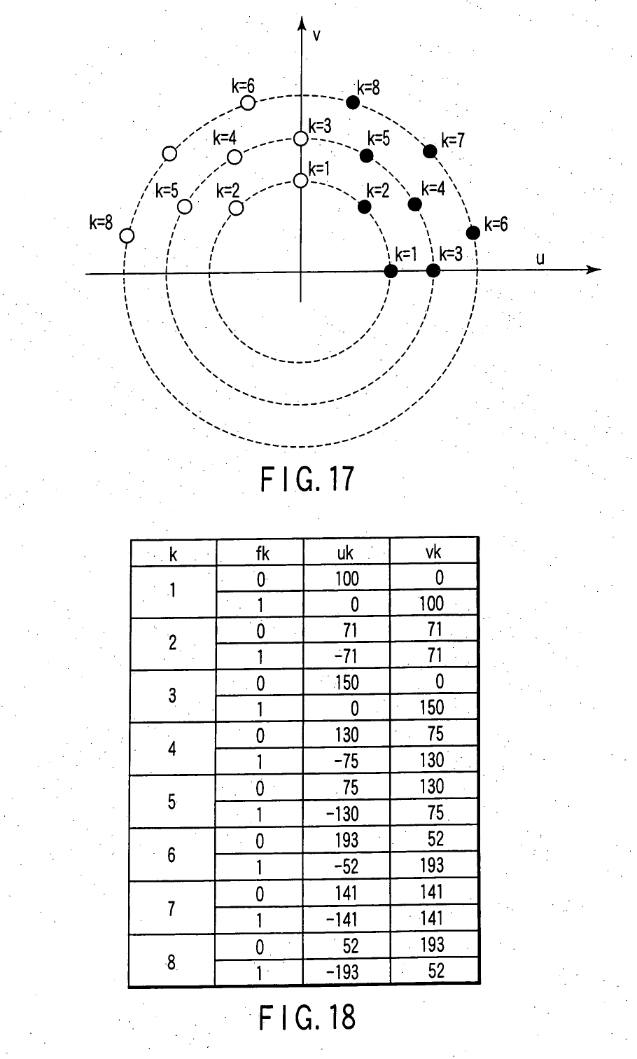

Specifically, the modulation section 4 assigns a group of two frequencies corresponding to 1 bit of the embedded data. For example, (u1, u2) are assigned corresponding to 1 bit of the embedded data. The frequency u1 is used when the embedded data is “0”. The frequency u2 is used when the embedded data is “1”. FIG. 17 is an arrangement diagram of frequency components of sine waves embedded by the modulation section 4. FIG. 18 shows correspondence among the frequency components.

In FIG. 17, a black circle “●” indicates one frequency. A white circle “◯” indicates the other frequency. The black circle “●” and the white circle “◯” constitute one group. For example, if a k-th bit of the embedded data is “0”, (u1, v1)=(100, 0) is established. If a bit is 1, (u1, v1)=(0.100) is established. As can be understood from FIGS. 17 and 18, two frequencies having absolute values equal to each other and angles shifted from each other by 90° are assigned as one group.

Generally, frequency components of a document image read by the image input section 1 are point-symmetrical in many cases. On such a premise, a group consisting of two frequencies is assigned corresponding to 1 bit of the embedded data. When such a premise is difficult to be established, the arrangement of a group consisting of two frequencies corresponding to 1 bit of the embedding data may be changed.

The modulation section 23 obtains a superimposed signal Q (x, y) by the equation (2) as in the case of the first embodiment. As shown in FIGS. 17 and 18, for example, 16 frequencies are used. As the two frequencies constitute a group for 1 bit, the embedded data becomes 8 bits. The bit number of the embedded data is half of that of the first embodiment.

As described above, according to the third embodiment, plural groups of frequencies, one group consisting of two frequencies, corresponding to values of the embedded data are assigned, and a superimposed signal Q (x, y) having the embedded data superimposed therein is generated by one of frequencies of one group in accordance with each value of the embedded data. As a result, it is possible to determine whether a frequency of the image is a data frequency component or a frequency component originally present in an original image. However, detection of the embedded data is difficult to be influenced by the frequency component contained in the original image.

Next, a fourth embodiment of the present invention will be described. Sections similar to those of FIG. 1 are denoted by similar reference numerals, and detailed description thereof will be omitted.

FIG. 17 is a block diagram of a data embedding apparatus. A thin line determination section 20 determines a thin line area of a predetermined width or less from an image signal P (x, y) of an image input section 1. For example, a detection method of a thin line area sets a predetermined reference window around a focused window, and makes determination based on connection and widths of pixels in the reference window to output a thin line area signal Th (x, y). The thin line area signal Th (x, y) indicates a value “1” in a thin line area and a value “0” outside the thin line area. Another detection method of a thin line area may be used.

A tone area determination section 21 determines a tone area, i.e., a photo area, in the image signal P (x, y). The tone area is constituted of a medium tone level other than black and white such as a photo, or a substrate or a character having a halftone. The tone area has a halftone area and a pseudo-halftone area. The halftone area is an area in which a level of the image signal P (x, y) includes a medium value. The pseudo-halftone area that is originally a halftone area is represented by a binary signal level by pseudo-halftone processing such as error diffusion processing or dot processing.

Inclusion of both or one of the halftone area and the pseudo-halftone area as tone areas depends on a system. According to the embodiment, both areas are dealt with.

According to a determination method of a halftone area, a level of the image signal P (x, y) is determined, and a pixel of a medium value is set as a tone area. Subsequently, the tone area is expanded, and its result is determined to be a tone area. Pixels of values “0”, “1” are included in a halftone area, and the expansion is carried out to include these pixels in the tone area.

According to a determination method of a pseudo-halftone area, expansion processing of a predetermined pixel is executed for a pixel of black “1”. Subsequently, labeling is executed based on connection in which a plurality of pixels of black “1” are continuously present. If both longitudinal and horizontal directions have connection of a size of predetermined value or more, an area constituted of these longitudinal and horizontal directions is determined as a pseudo-halftone area.

In the pseudo-halftone area, the pixels of black “1” are close to each other. By expanding the pseudo-halftone area, the pixels of black “1” are connected together to constitute a large connected area. On the other hand, in a character or a line drawing, character or line parts are separated from each other. Thus, the character or the line drawing is difficult to become a large connected area.

As a result of such determination, the tone area determination section 21 outputs a tone area signal Gr (x, y).

The area determined to be a halftone area or a pseudo-halftone area takes a value “1”, and other areas take values “0”.

A superimposing section 22 receives the image signal P₂ (x, y) output from a smoothing section 2, the thin line area signal Th (x, y) output from the thin line determination section 20, the tone area signal Gr (x, y) output from the tone area determination section 21, and a superimposed signal Q (x, y) output from a modulation section 4, and superimposes the superimposed signal Q (x, y) on the image signal P₂ (x, y).

In this case, the superimposing section 22 does not superimpose the superimposed signal Q (x, y) on the image signal P₂ (x, y) in the thin line area indicated by the thin line area signal Th (x, y) and the tone area indicated by the tone area signal Gr (x, y). In other words, the superimposing section 22 executes the following processing in which P₃ (x, y) is an output signal thereof:
if (Th(x, y)=1 or Gr(x, y)=1) P₃(x, y)=P₂(x, y)
if (Th(x, y)=0 and Gr(x, y)=0) P₃ (x, y)=P₂(x, y)+Q(x, y) (10)

A binarizing section 6 executes binarization as in the case of the first embodiment. According to this embodiment, Inclusion of a tone area in an image is a premise. Accordingly, the binarizing section 6 receives the tone area signal Gr (x, y) from the tone area determination section 21, but does not binarize a tone area of the output signal P₃ (x, y) of the superimposing section 22. That is, the binarizing section 6 masks binarization processing by the tone area signal Gr (x, y). The binarizing section 6 executes processing represented by the following equation (11) to obtain an output signal P₄ (x, y):
if (Gr(x, y)=1) P₄(x, y)=P₃(x, y)
if (Gr(x, y)=0 and P₃(x, y)≧0.5) P₄(x, y)=1
if (Gr(x, y)=0 and P₃(x, y)<0.5) P₄(x, y)=0 (11)

Next, a data embedding operation of the apparatus thus configured will be described.

The image input section 1 inputs an image as an image signal P (x, y). The smoothing section 2 smoothes the image signal P (x, y) output from the image input section 1.

The data input section 3 inputs embedded data represented as, e.g., a finite-bit digital signal. The modulation section 4 generates a superimposed signal Q (x, y) having the embedded data input from the data input section 3 superimposed therein. For example, the modulation section 4 generates the superimposed signal Q (x, y) by stacking 2-dimensional sine waves of 16 kinds of spatial frequencies together.

The thin line determination section 20 determines a thin line area of a predetermined width or less from the image signal P (x, y) from the image input section 1. The thin line determination section 20 outputs a thin line area signal Th (x, y) which is a determination result of the thin line area.

The tone area determination section 21 determines a tone area constituted of a medium tone level other than black and white such as a photo, or a substrate or a character having a halftone in the image signal P (x, y) . . . The tone area includes both of a halftone area and a pseudo-halftone area. The tone area determination section 21 outputs a tone area signal Gr (x, y) as a result of determination.

The superimposing section 22 receives the image signal P₂ (x, y) output from a smoothing section 2, the thin line area signal Th (x, y) output from the thin line determination section 20, the tone area signal Gr (x, y) output from the tone area determination section 21, and a superimposed signal Q (x, y) output from a modulation section 4, and superimposes the superimposed signal Q (x, y) on the image signal P₂ (x, y). In this case, the superimposing section 22 does not superimpose the superimposed signal Q (x, y) on the image signal P₂ (x, y) in the thin line area indicated by the thin line area signal Th (x, y) and the tone area indicated by the tone area signal Gr (x, y). The superimposing section 22 outputs a signal P₃ subjected to superimposition processing.

The binarizing section 6 receives the tone area signal Gr (x, y) from the tone area determination section 21, masks a tone area of the output signal P3 (x, y) of the superimposing section 22, and executes binarization processing for an area other than the tone area. As a result, a concave and convex shape G is added to the edge of the image signal P (x, y) in accordance with the embedded data.

As described above, according to the fourth embodiment, superimposition of the embedded data is not carried out in the thin line area of a predetermined width or less, and the tone area constituted of the medium tone level other than black and white such as a photo, or a substrate or a character having a halftone. Therefore, a modulation of a concave and convex shape is selectively carried out only for a character, a line or an edge of a certain thickness. As a result, it is possible to prevent image quality deterioration such as a broken thin line or generation of texture in the tone area.

Next, a fifth embodiment of the present invention will be described with reference to the drawings.

FIG. 20 is a configuration diagram of an image forming apparatus (printing system). This apparatus has an image falsification prevention function. A control section 30 has a CPU. A program memory 31, a data memory 32, a printer 33, and a document file input section 34 are connected to the control section 30. The control section 50 issues operation commands to a rendering section 35, a code data extraction section 36, and an embedding section 37.

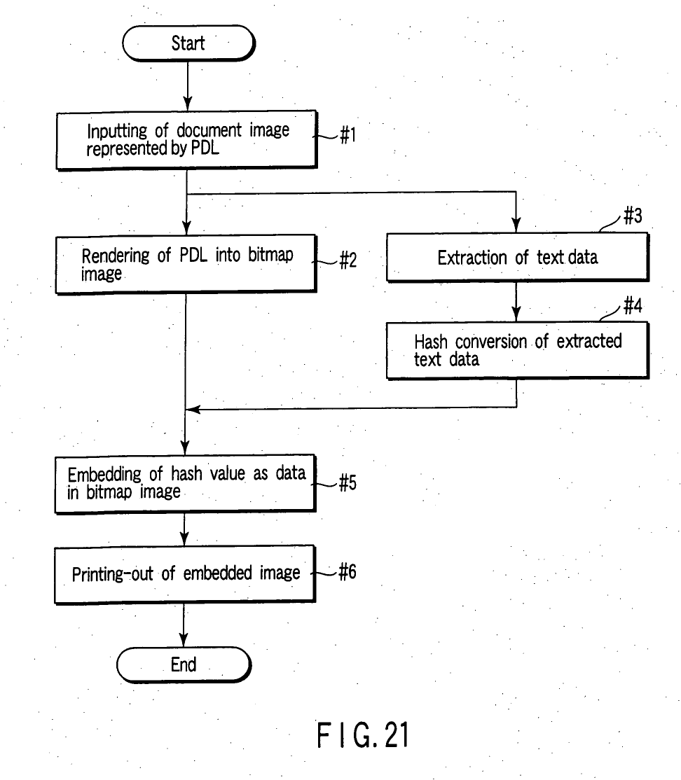

The program memory 31 prestores a printing processing program. For example, the printing processing program describes commands or the like for executing processing in accordance with printing processing flowchart of FIG. 21.

A document file, image data or the like is temporarily stored in the data memory 32.

The printer 33 forms an image in an image forming medium such as a recording sheet.

The document file input section 34 inputs a document file. For example, the document file is described in various page description languages (PDL).

The rendering section 35 renders the document file input from the document file input section 34 into, e.g., a bit map image.

The code data extraction section 36 extracts text data as code data from the document file input form the document file input section 34. The code data becomes embedded data. The code data extraction section calculates a hash value based on the extracted text code data. The hash value is data uniquely generated by the text code data. For example, the hash value is obtained by exclusive OR of all the character codes. Here, for example, the hash value is set to 16 bits.

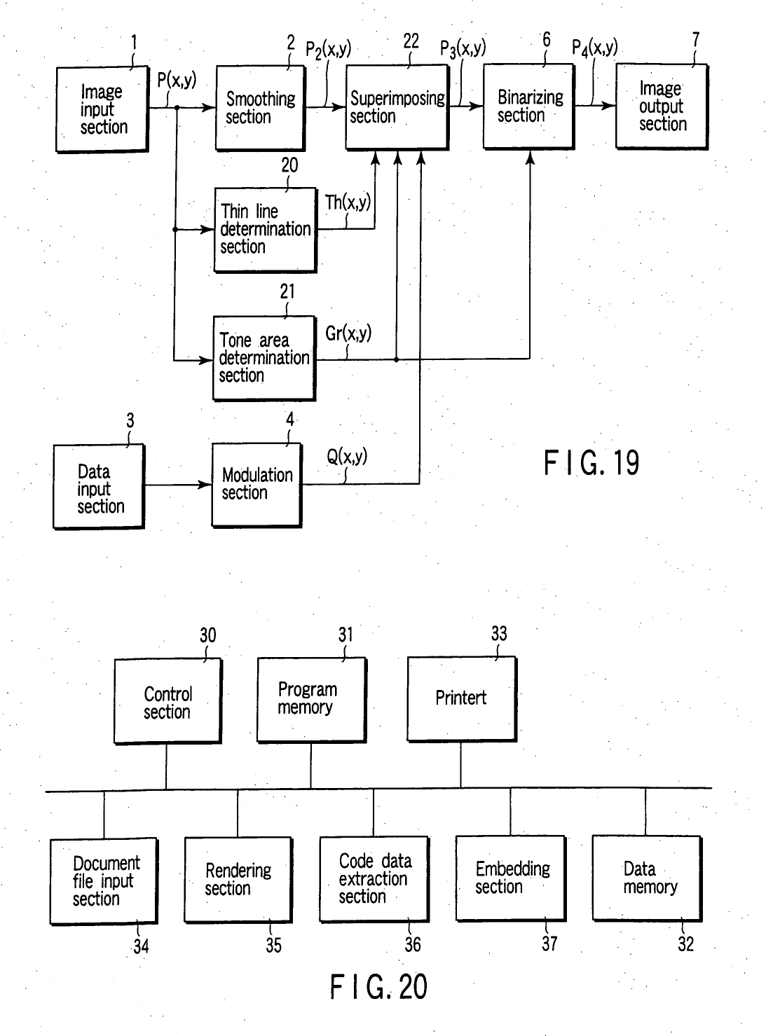

The embedding section 37 embeds the hash value in a bitmap image. For example, the embedding section 37 includes the data embedding apparatus of one of the first to fourth embodiments. For example, the embedding section 37 includes the data embedding apparatus shown in FIG. 1. That is, the embedding section 37 includes an image input section 1, a smoothing section 2, a data input section 3, a modulation section 4, a superimposing section 5, a binarizing section 6, and an image output section 7. For example, the embedding section 37 includes the data embedding apparatus shown in FIG. 15. That is, the embedding section 37 includes an image input section 1, a data input section 3, a modulation section 4, an edge determination section 10, a superimposing section 11, a binarizing section 6, and an image output section 7. For example, the embedding section 37 includes the data embedding apparatus shown in FIG. 19. That is, the embedding section 37 includes an image input section 1, a smoothing section 2, a data input section 3, a modulation section 4, a thin line determination section 20, a tone area determination section 21, a superimposing section 22, a binarizing section 6, and an image output section 7.

Next, an image forming operation of the apparatus thus configured will be described with reference to a printing processing flowchart of FIG. 21.

First, in step #1, for example, the document file input section 34 inputs a document file written in each of various page description languages.

Next, in step #2, the rendering section 35 renders the document file input from the document file input section 34 into, e.g., a bitmap image.

Associatively, in step #3, the code date extraction unit 36 extracts text data as code data from the document file input from the document file input section 34.

Next, in step #4, the code data extraction section 36 calculates a hash value uniquely generated by text code data based on the extracted text code data. Here, the hash value is set to, e.g., 16 bits.

Next, in step #5, the embedding section 37 embeds the hash value from the code data extraction section 36 in the bitmap image from the rendering section 35. The embedding section 37 executes an operation similar to that of one of the first to fourth embodiments. For example, when the embedding section 37 includes the data embedding apparatus of the first embodiment, the image input section 1 inputs a bitmap image as an image signal. The smoothing section 2 smoothes the image signal output from the image input section 1. The data input section 3 inputs a hash value. The modulation section 4 generates a superimposed signal having the hash value input from the data input section 3 superimposed therein. The superimposing section 5 adds the superimposed signal generated by the modulation section 4 to an edge of the image signal smoothed by the smoothing section 2. The binarizing section 6 binarizes the image signal to which the superimposed signal has been added, and adds a concave and convex shape to the edge in accordance with the embedded data. The image output section 7 outputs the image signal binarized by the binarizing section 6.

The embedding section 37 is not limited to the first embodiment, but executes an operation similar to that of any one of the second to fourth embodiments. That is, according to one of the second to fourth embodiments, the image input from the image input section 1 may be replaced by a bitmap image, and the embedded data input from the data input section 3 may be replaced by a hash value. When the embedding section 37 includes the apparatus of one of the second to fourth embodiments, the operation is the same, and thus description will be omitted to avoid repetition.

Next, in step #6, the printer 33 prints out the image having the hash value embedded therein in an image forming medium such as a recording sheet.

As described above, according to the fifth embodiment, the hash value generated from the code data extracted from the document file is embedded in the bitmap image obtained by rendering the document file. Hence, it is possible to embed the code data in a document printed in the image recording medium in accordance with contents of the document file.

As a result, if the document file is falsified or copied to lose the embedded data, the embedded data and the contents of the document file do not match each other. However, the embedded data is reproduced, and the contents of the document file are read as code data by an OCR or the like. A hash value is calculated from the read code data. The hash value is compared with the contents of the document file. Falsification or illegal copying of the document file can be discovered from a result of the comparison. As a result, it is possible to indirectly prevent falsification of the document file.

By applying one of the first to fourth embodiments to, e.g., the printer, the printer can be provided with a falsification or authentication function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A data embedding apparatus comprising:
a smoothing section which smoothes an image signal;
a modulation section which generates a superimposed signal in accordance with embedded data;
a superimposing section which adds the superimposed signal generated by the modulation section to the image signal smoothed by the smoothing section; and
a binarizing section which binarizes the image signal having the superimposed signal added thereto by the superimposing section.

2. The data embedding apparatus according to claim 1, wherein:
the image signal has an edge in which a signal level value steeply changes; and
the smoothing section smoothes the image signal to set the edge to a medium signal level value.

3. The data embedding apparatus according to claim 1, wherein the embedded data contains at least 1-bit data.

4. The data embedding apparatus according to claim 1, wherein the modulation section generates the superimposed signal by stacking 2-dimensional sine waves of a plurality of spatial frequencies together.

5. The data embedding apparatus according to claim 4, wherein the modulation section generates the superimposed signal having a clip function or the clip function applied thereto.

6. The data embedding apparatus according to claim 1, wherein:
the image signal has an edge in which a signal level value steeply changes;
the smoothing section smoothes the edge of the image signal; and
the superimposing section adds the superimposed signal to the edge smoothed by the smoothing section.

7. The data embedding apparatus according to claim 6, wherein the binarizing section binarizes the image signal having the superimposed signal added thereto, and adds a concave and convex shape to the edge in accordance with the embedded data.

8. The data embedding apparatus according to claim 1, wherein:
the embedded data takes values different from one another; and
the modulation section has at least one group of two frequencies corresponding to each value of the embedded data, and generates the superimposed signal having the embedded data superimposed therein by one of the frequencies of the group in accordance with each value of the embedded data.

9. A data embedding apparatus comprising:
an edge determination section which determiners an edge having a signal level value of an image signal steeply changed;
a modulation section which generates a superimposed signal having embedded data superimposed therein;
a superimposing section which adds the superimposed signal generated by the modulation section to the edge determined by the edge determination section; and
a binarizing section which binarizes the image signal having the superimposed signal added thereto by the superimposing section.

10. The data embedding apparatus according to claim 9, wherein the embedded data contains at least 1-bit data.

11. The data embedding apparatus according to claim 9, wherein the modulation section generates the superimposed signal by stacking 2-dimensional sine waves of a plurality of spatial frequencies together.

12. The data embedding apparatus according to claim 9, wherein the modulation section has a clip function.

13. The data embedding apparatus according to claim 9, wherein the binarizing section binarizes the image signal having the superimposed signal added thereto, and adds a concave and convex shape to the edge in accordance with the embedded data.

14. A data embedding apparatus comprising:
a smoothing section which smoothes an image signal;
a modulation section which generates a superimposed signal having embedded data superimposed therein;
a thin line determination section which determines a thin line area of a predetermined width or less from the image signal;
a tone area determination section which determines a tone area in the image signal;
a superimposing section which adds the superimposed signal generated by the modulation section to an area other than the thin line area determined by the thin line determination section and the tone area determined by the tone area determination section in the image signal smoothed by the smoothing section; and
a binarizing section which binarizes the image signal having the superimposed signal added thereto by the superimposing section.

15. The data embedding apparatus according to claim 14, wherein:
the image signal has an edge in which a signal level value steeply changes; and
the smoothing section smoothes the image signal to set the edge to a medium signal level value.

16. The data embedding apparatus according to claim 14, wherein the embedded data contains at least 1-bit data.

17. The data embedding apparatus according to claim 14, wherein the modulation section generates the superimposed signal by stacking 2-dimensional sine waves of a plurality of spatial frequencies together.

18. The data embedding apparatus according to claim 17, wherein the modulation section has a clip function.

19. The data embedding apparatus according to claim 14, wherein the tone area determination section determines a tone area constituted of a medium tone level other than white and black levels.

20. The data embedding apparatus according to claim 19, wherein the tone area determination section determines, as the tone areas, a halftone area having a level of the image signal containing a medium value other than the white and black levels and a pseudo-halftone area having a signal level represented in a binary state by pseudo-halftone processing.

21. The data embedding apparatus according to claim 14, wherein the binarizing section binarizes the image signal having the superimposed signal added thereto, and adds a concave and convex shape o the edge in accordance with the embedded data.

22. An image forming apparatus comprising:
an input section which inputs a document file;
a conversion section which converts the document file into an image signal;
an extraction section which extracts embedded data from the document file;
an embedding section which adds the embedded data extracted by the extraction section to the image signal converted by the conversion section;
a binarizing section which binarizes the image signal having the embedded data added thereto by the embedding section; and
an image forming section which forms an image of the image signal binarized by the binarizing section in an image forming medium.

23. The image forming apparatus according to claim 22, wherein:
the image signal has an edge in which a signal level value steeply changes; and
the embedding section includes a smoothing section to smooth the edge of the image signal, and a superimposing section to add a superimposed signal to the edge smoothed by the smoothing section.

24. The image forming apparatus according to claim 22, wherein:
the embedding section includes a thin line determination section to determine a thin line area of a predetermined width or less from the image signal, and a tone area determination section to determine a tone area in the image signal; and
the superimposing section adds the superimposed signal generated by the modulation section to an area other than the thin line area determined by the thin line determination section and the tone area determined by the tone area determination section in the image signal.

25. A data embedding method comprising:
smoothing an image signal;
generating a superimposed signal having embedded data superimposed therein;
adding the superimposed signal to the smoothed image signal; and
binarizing the image signal having the superimposed signal added thereto.

26. A data embedding method comprising:
determining an edge having a signal level value of an image signal steeply changed;
generating a superimposed signal having embedded data superimposed therein;
adding the superimposed signal to the edge; and
binarizing the image signal having the superimposed signal added thereto.

27. A data embedding method comprising:
smoothing an image signal;
generating a superimposed signal having embedded data superimposed therein;
determining a thin line area of a predetermined width or less from the image signal;
determining a tone area in the image signal;
adding the superimposed signal to an area other than the thin line area and the tone area in the smoothed image signal; and
binarizing the image signal having the superimposed signal added thereto.
